(19) United States
(12) Patent Application Publication
(10) Pub. No.: US 2016/0188027 A1
(43) Pub. Date: Jun. 30, 2016

(54) OPTICAL TOUCH DISPLAY

(71) Applicant: QUANTA COMPUTER INC., Taoyuan City (TW)

(72) Inventors: Yun-Cheng LIU, New Taipei City (TW); Chien-Hung LIN, Taoyuan City (TW)

(73) Assignee: QUANTA COMPUTER INC., Taoyuan City (TW)

(21) Appl. No.: 14/667,016

(22) Filed: Mar. 24, 2015

(30) Foreign Application Priority Data
Dec. 30, 2014 (TW) 103146337

(51) Int. Cl. G06F 3/042; G06F 3/041

(52) U.S. Cl. CPC G06F 3/042; G06F 3/0412

(57) ABSTRACT

An optical touch display includes a display panel, a lens module disposed at a corner of the display panel, and a processing unit. The lens module includes a circuit board, a first light receiving unit disposed on the circuit board, and a second light receiving unit disposed on the circuit board. The first light receiving unit has a first coordinate. The images provided by the first light receiving unit and the second light receiving unit are sent to the processing unit, and a distance between an object and the first light receiving unit is calculated by the processing unit, such that a second coordinated of the object on the display panel is obtained according to the first coordinate, the distance, and an angle defined by a line connecting the object to the first light receiving unit and an top edge of the display panel.

### RELATED APPLICATIONS

This application claims priority to Taiwan Application Serial Number 103146337, filed Dec. 30, 2014, which is herein incorporated by reference.

### BACKGROUND

1. Field of Invention

The present invention relates to a touch display. More particularly, the present invention relates to an optical touch display.

2. Description of Related Art

Touch technology refers to a combination of display and input modules of an electronic device. A user can control the electronic device simply by pressing or touching the display. The touch screen is normally categorized into three types, resistive type, capacitive type, and optical type. For the optical touch screen, because there are no traces used for sensing being disposed between the glass and the panel, this type of the touch screen may have a cost advantage when utilized as a large-size touch screen.

However, the optical touch display needs extra space for setting the light emitter and the light receiver. Therefore, there is a need to reduce the space for the light emitter and the light receiver when the optical touch display is used.

### SUMMARY

The present invention provides an optical touch display, in which the lens module is disposed at single corner of the optical touch display, such that the space of the optical touch display can be reduced.

Furthermore, the optical touch display calculates the angle of the object and the distance between the object and the lens module according to the images captured by the lens module thereby obtaining the coordinate of the object.

An aspect of the invention provides an optical touch display, which includes a display panel, a lens module disposed at a corner of the display panel, and a processing unit. The lens module includes a circuit board, a first light receiving unit disposed on the circuit board, and a second light receiving unit disposed on the circuit board. The first light receiving unit has a first coordinate. Fields of views of the first light receiving unit and the second light receiving unit cover the display panel. The images provided by the first light receiving unit and the second light receiving unit are sent to the processing unit, and a distance between an object and the first light receiving unit is calculated by the processing unit, such that a second coordinated of the object on the display panel is obtained by calculating according to the first coordinate, the distance, and an angle defined by a line connecting the object to the first light receiving unit and an top edge of the display panel.

In one or more embodiments, the first light receiving unit and the second light receiving unit are mono image sensors, and the optical touch display further includes an infrared ray emitter disposed between the first light receiving unit and the second light receiving unit.

In one or more embodiments, the first light receiving unit and the second light receiving unit are color image sensors.

In one or more embodiments, the lens focal length of the first light receiving unit is substantially same as that of the second light receiving unit

In one or more embodiments, the optical touch display further includes a third light receiving unit disposed on the circuit board. The first light receiving unit, the second light receiving unit and the third light receiving unit in pairs provide three of the second coordinates, and a coordinate of the object on the display panel is obtained by weight distributing the second coordinates.

In one or more embodiments, the first light receiving unit, the second light receiving unit, and the third light receiving unit are mono image sensors, and the optical touch display further includes an infrared ray emitter disposed on the circuit board.

In one or more embodiments, the first light receiving unit, the second light receiving unit, and the third light receiving unit are color image sensors.

In one or more embodiments, the first light receiving unit, the second light receiving unit and the third light receiving unit have substantially the same lens focal length.

The lens module is assembled at a corner of the display panel, such that the space of the optical touch display can be saved, and the optical touch display still provides function of full-zone touch control.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a top view schematic diagram of an embodiment of an optical touch display of the invention;

FIG. 2 is a schematic view illustrating a relative position of the object, the first light receiving unit, and the second light receiving unit of the optical touch display of the invention;

FIG. 3 is a schematic view of an image captured by the first light receiving unit;

FIG. 4 is a schematic view of another image captured by the second light receiving unit;

FIG. 5 is a schematic view of angle calibration after the optical touch display is assembled;

FIG. 6 is a schematic view of the calculating the coordinate of the object of an embodiment of the optical touch display of the invention;

FIG. 7 is a top view of another embodiment of the optical touch display of the invention; and

FIG. 8 is a top view of yet another embodiment of the optical touch display of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

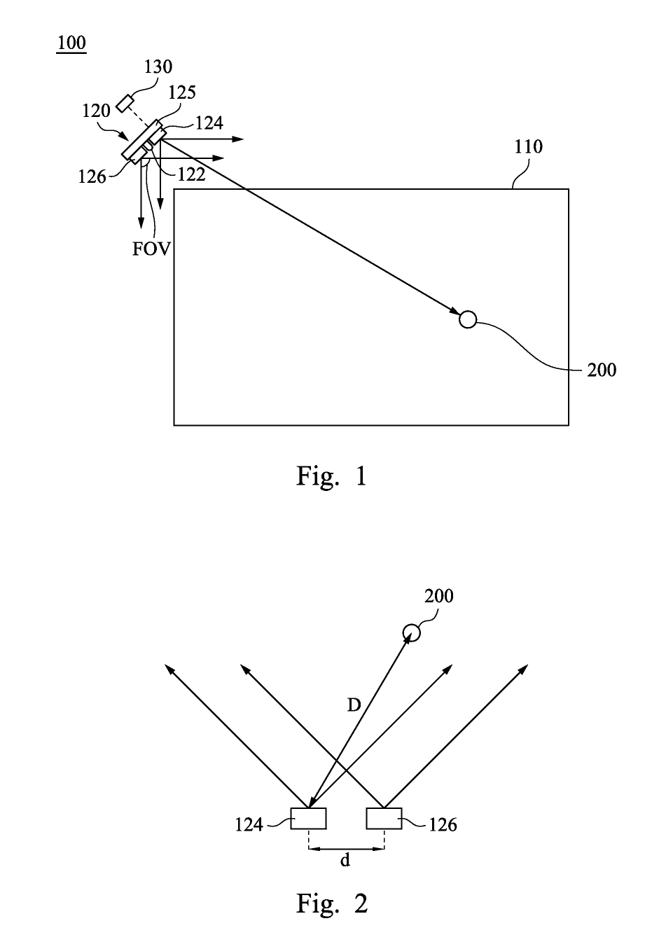

FIG. 1 is a top view schematic diagram of an embodiment of an optical touch display of the invention. The optical touch display 100 includes a display panel 110, a lens module 120 disposed at a corner of the display panel 110, and a processing unit 130. The display panel 110 is a flat display panel, such as a liquid crystal display or a plasma display. The display panel 110 has plural sides and plural corners defined by the sides. The lens module 120 is disposed at one of the corners, and the processing unit 130 is electrically connected to the lens module 120.

The lens module 120 has a light emitting unit 122, a first light receiving unit 124 and a second light receiving unit 126. The first light receiving unit 124 and the second light receiving unit 126 are disposed at opposite sides of the light emitting unit 122. In this embodiment, the light emitting unit 122 is an infrared ray emitter for emitting invisible light. The first light receiving unit 124 and the second light receiving unit 126 are image sensors for receiving the infrared ray images. In some embodiments, the first light receiving unit 124 and the second light receiving unit 126 are mono image sensors.

The first light receiving unit 124 and the second light receiving unit 126 respectively captures images above the display panel 110. For example, the light emitting unit 122 emits light passing through the top surface of the display panel 110. When an object (such as a finger or a stylus) comes close to or touches the display panel 110, the first light receiving unit 124 and the second light receiving unit 126 can receive the light reflected from the object (or the first light receiving unit 124 and the second light receiving unit 126 can record an image of the object illuminated by the light). The images captured by the first light receiving unit 124 and the second light receiving unit 126 are sent to the processing unit 130, and a coordinate of the object is calculated according to the images.

The field of view (FOV) of the first light receiving unit 124 covers the touch zone of the display panel 110 (e.g. the display zone of the display panel 110). The FOV of the second light receiving unit 126 covers the touch zone of the display panel 110 (e.g. the display zone of the display panel 110). In a preferred embodiment, the FOVs of the first light receiving unit 124 and the second light receiving unit 126 are greater than 90 degrees, such that the distance between the lens module 120 and the display panel 110 can be shortened. The first light receiving unit 124 and the second light receiving unit 126 have substantially the same lens focal length.

The lens module 120 further includes a circuit board 125 for fastening the light emitting unit 122, the first light receiving unit 124, and the second light receiving unit 126 thereon. The circuit board 125 is electrically connected to the processing unit 130. The processing unit 130 can be a processor disposed on the circuit board 125. The processing unit 130 can be connected to a computer by wire. In some embodiments, the lens module 120 can be detachably assembled to the display panel 110. Namely, the lens module 120 is hung at the corner of the display panel 110. In some embodiments, the lens module 120 is embedded in the frame of the display panel 110.

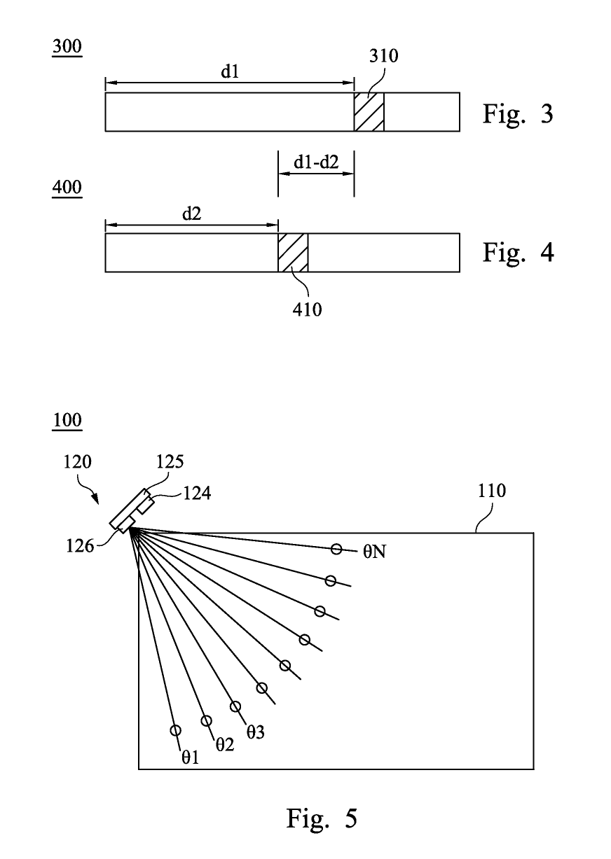

Reference is made to FIG. 2 to FIG. 4, in which FIG. 2 is a schematic view illustrating a relative position of the object, the first light receiving unit 124, and the second light receiving unit 126 of the optical touch display of the invention; FIG. 3 is a schematic view of an image captured by the first light receiving unit 124; FIG. 4 is a schematic view of another image captured by the second light receiving unit 126.

Referring to FIG. 2, there is a distance d between the first light receiving unit 124 and the second light receiving unit 126. The distance d can be defined between the centers of the first light receiving unit 124 and the second light receiving unit 126, or between the left (right) edges of the first light receiving unit 124 and the second light receiving unit 126. When the object 200 is located on the display panel (whether touching the display panel or not), the coordinate of the object 200 is obtained according to the images provided by the first light receiving unit 124 and the second light receiving unit 126. Details of calculating the coordinate of the object 200 are described as following.

Since the distance d is made between the first light receiving unit 124 and the second light receiving unit 126, the position of the object of the images captured by the first light receiving unit 124 and the second light receiving unit 126 are different from each other. Referring to FIG. 3, which is the image 300 captured by the first light receiving unit 124, the object 200 reflects light, such that the section 310 with higher brightness is made in the image 300. Also, referring to FIG. 4, which is the image 400 captured by the second light receiving unit 126, the object 200 reflects light, such that the section 410 with higher brightness is made in the image 400. In some embodiments, the first light receiving unit 124 is a master light receiving unit since the second light receiving unit 126 is a slave light receiving unit, a formula

$$D = d \times \frac{f}{\vert d 1 - d 2 \vert}$$

is utilized for calculating the coordinate of the object, in which d represents the distance between the first light receiving unit 124 and the second light receiving unit 126; f represents the lens focal length of the first light receiving unit 124 and the second light receiving unit 126; |d1−d2| represents the gap between the section 310 and the section 410. More particularly, d1 represents the distance between the left (right) edge of the section 310 and the left (right) edge of the image 300; d2 represents the distance between the left (right) edge of the section 410 and the left (right) edge of the image 400. After the distance d1 minuses the distance d2, the absolute value, which is always positive, the gap between the section 310 and the section 410 of the image 300 and the image 400 respectively is obtained. The distance d between the first light receiving unit 124 and the second light receiving unit 126, the lens focal length f of the first light receiving unit 124 and the second light receiving unit 126 are already known when the optical touch display is provided. The gap |d1−d2| between the section 310 and the section 410 is obtained by the process as discussed previously. Therefore, a distance D between the object 200 and the first light receiving unit 124 can be obtained with the formula

$$D = d \times \frac{f}{\vert d 1 - d 2 \vert} .$$

FIG. 5 is a schematic view of angle calibration after the optical touch display is assembled. In order to present more clearly, FIG. 5 only illustrates the calibration process of the second light receiving unit 126. The calibration process of the first light receiving unit 124 is similar to the second light receiving unit 126 and is not described again.

Plural record points with predetermined angles θ1 to θN are set on the display panel 110. Then the record points are touched by the object, such as a finger or a stylus, and the images thereof are captured. The pixel position of the object in the image, which has higher brightness, of the record point with already known angle is obtained. A database of angle to pixel position is established by repeating above steps. Therefore, the angle of the object on the display panel 110 can be recognized by the pixel position image. The angle of the object is angle defined between a line connecting the object to the second light receiving unit 126 and a top side of the display panel 110.

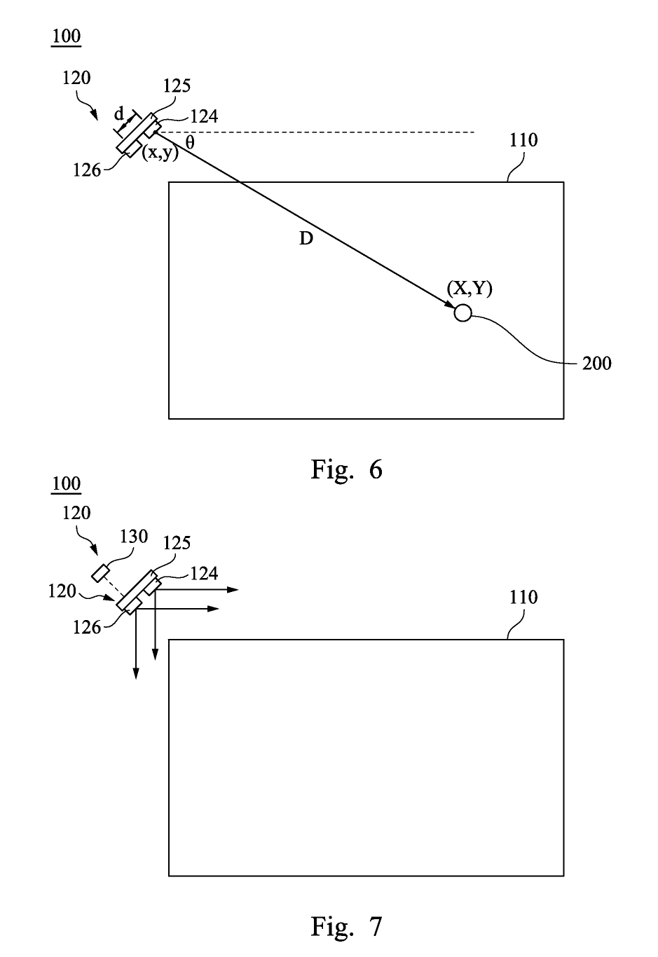

FIG. 6 is a schematic view of the calculating the coordinate of the object of an embodiment of the optical touch display of the invention. As discussed in FIG. 2 to FIG. 5, the distance D between the object 200 and the first light receiving unit 124, and the angle θ of the object 200 are obtained. Also, the position of the lens module 120 is fixed after the optical touch display 100 is assembled, such that the coordinate (x, y) of the first light receiving unit 124 is known. In some embodiment, a simultaneous equations including a Pythagorean theorem formula and a point slope formula is utilized for calculating the coordinate (X, Y) of the object 200. In some embodiments, a simultaneous equations including a circle equation (X−x)²+(Y−y)²=D² and a linear equation

$$\frac{Y - y}{X - x} = tan θ$$

is utilized for calculating the coordinate (X, Y) of the object 200. After the coordinate (X, Y) of the object is obtained, actions such as moving cursor can be executed according to the variation of the coordinate (X, Y) of the object 200.

The method of calculating the coordinate (X, Y) of the object 200 is fully described in aforementioned embodiments. The following embodiments would focus on the structural differences of the optical touch display 100, in which the method of calculating the coordinate (X, Y) is similar to the previous embodiments.

FIG. 7 is a top view of another embodiment of the optical touch display of the invention. In this embodiment, the first light receiving unit 124 and the second light receiving unit 126 of the lens module 120 are color image sensors. The light emitting unit 122 in FIG. 1 is omitted in this embodiment. The object utilized in this embodiment is preferably a finger. The processing unit 130 can recognize the skin-color portion in the images or recognize the shape of the finger by image analysis thereby determining the pixel position of the object.

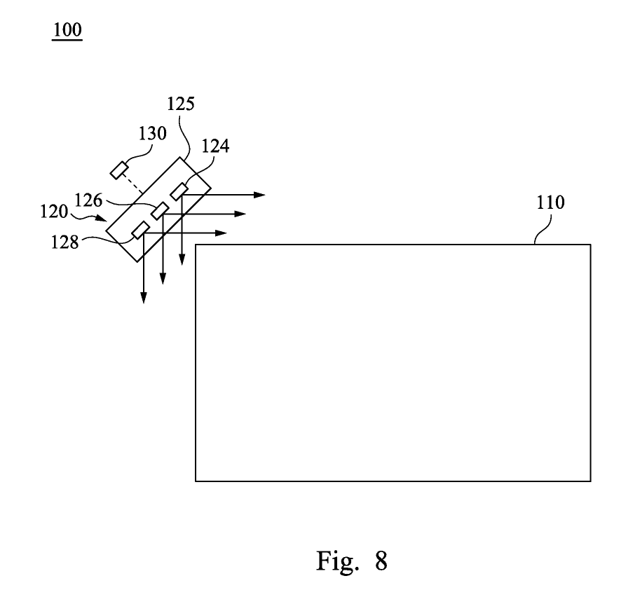

FIG. 8 is a top view of yet another embodiment of the optical touch display of the invention. In this embodiment, the lens module 120 further includes a third light receiving unit 128. The first light receiving unit 124, the second light receiving unit 126, and the third light receiving unit 128 are disposed on the circuit board 125. The lens module 120 can be hung on the display panel 110 detachably or embedded in the frame of the display panel 110.

In some embodiments, the first light receiving unit 124, the second light receiving unit 126, and the third light receiving unit 128 can be mono image sensors, and a invisible light source, such as an infrared ray emitter is required. In some embodiments, the first light receiving unit 124, the second light receiving unit 126, and the third light receiving unit 128 are color image sensors, and the optical touch display 100 is preferably operated by finger(s), such that the color of the object can be recognized easily.

The first light receiving unit 124, the second light receiving unit 126, and the third light receiving unit 128 can work in pairs thereby providing three of the coordinates when the position of the object is determined. The coordinate of the object is obtained by weight distributing the three coordinates, such that the position of the object can be determined more precisely. For example, the coordinate of the object can be the mean point of the three coordinates. Furthermore, if one of the three coordinates is obviously far away from the others, the coordinate is excluded at the calculation process, such that the position of the object can be determined more precisely.

According to above embodiments, the lens module is assembled at a corner of the display panel, such that the space of the optical touch display can be saved, and the optical touch display still provides function of full-zone touch control.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical touch display, comprising:
a display panel;
a lens module disposed at a corner of the display panel, the lens module comprising:
a circuit board;
a first light receiving unit disposed on the circuit board, the first light receiving unit having a first coordinate; and
a second light receiving unit disposed on the circuit board, wherein fields of views of the first light receiving unit and the second light receiving unit cover the display panel; and
a processing unit electrically connected to the lens module, wherein images provided by the first light receiving unit and the second light receiving unit are sent to the processing unit, and a distance between an object and the first light receiving unit is calculated by the processing unit, such that a second coordinated of the object on the display panel is obtained according to the first coordinate, the distance, and an angle defined by a line connecting the object to the first light receiving unit and an top edge of the display panel.

2. The optical touch display of claim 1, wherein the first light receiving unit and the second light receiving unit are mono image sensors.

3. The optical touch display of claim 2, further comprising:
an infrared ray emitter disposed between the first light receiving unit and the second light receiving unit.

4. The optical touch display of claim 1, wherein the first light receiving unit and the second light receiving unit are color image sensors.

5. The optical touch display of claim 1, wherein a lens focal length of the first light receiving unit is substantially same as that of the second light receiving unit.

6. The optical touch display of claim 1, further comprising a third light receiving unit disposed on the circuit board, wherein the first light receiving unit, the second light receiving unit and the third light receiving unit in pairs provide three of the second coordinates, and a coordinate of the object on the display panel is obtained by weight distributing the second coordinates.

7. The optical touch display of claim 6, wherein the first light receiving unit, the second light receiving unit, and the third light receiving unit are mono image sensors.

8. The optical touch display of claim 7, further comprising:
an infrared ray emitter disposed on the circuit board.

9. The optical touch display of claim 6, wherein the first light receiving unit, the second light receiving unit, and the third light receiving unit are color image sensors.

10. The optical touch display of claim 6, wherein the first light receiving unit, the second light receiving unit and the third light receiving unit have substantially the same lens focal length
